(19) United States
(12) Patent Application Publication
(10) Pub. No.: US 2006/0144529 A1
(43) Pub. Date: Jul. 6, 2006

(54) Automated door openers

(75) Inventor: Dallas Hemphill, Philomath, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Emerge Technologies, Inc.

(21) Appl. No.: 11/029,831

(22) Filed: Jan. 4, 2005

(51) Int. Cl. E05F 15/00

(52) U.S. Cl. 160/188

(57) ABSTRACT

A door opening apparatus adapted to couple with a door. The door opening apparatus includes a motor coupled to the door and operationally coupled to a drive wheel adapted to roll along the frame of a door.

### BACKGROUND OF THE INVENTION

1. Field of the Invention

Embodiments of the present invention relate to, but are not limited to, door devices, and in particular, to the field of automated door opening and/or closing devices.

2. Description of Related Art

In the current state of door opener technology several types of door opening and/or closing devices are available for automated opening and/or closing of doors that, for example, open and close laterally, vertically, or rotationally about a pivot point. Such doors may include for example, accordion-type doors, sliding doors, window shutters or blinds, room partitions, tambour doors on desks, and the like.

Typically these door-opening devices are mounted to or within the frame of the door or on or in the walls/surfaces generally surrounding the door rather than on the door itself. The driving mechanisms employed by these openers often include a number of components mounted away from the door itself, such as the periphery of the frame.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a door opening apparatus on an accordion type of door in accordance with some embodiments of the present invention;

FIG. 2 illustrates the door opening apparatus of FIG. 1, in further detail, in accordance with some embodiments of the present invention;

FIG. 3 illustrates an exploded view of a bearing block in accordance with some embodiments of the present invention;

FIG. 4 illustrates two door opening apparatuses disposed on opposite sides of a door in accordance with some embodiments of the present invention;

FIG. 5 illustrates a door opening apparatus and a idler wheel component disposed on opposite sides of a door in accordance with some embodiments of the present invention;

FIGS. 6 to 8 are block diagrams of door opening systems in accordance with some embodiments of the present invention;

FIG. 9 illustrates door opening apparatus in accordance with some embodiments of the present invention.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention.

The following description includes terms such as lateral, vertical, top, bottom, inward, outward, away, and the like, that are used for descriptive purposes only and are not to be construed as limiting. That is, these terms are terms that are relative only to a point of reference and are not meant to be interpreted as limitations but are instead, included in the following description to facilitate understanding of the various aspects of the invention.

According to various embodiments, apparatuses for opening and/or closing doors (herein “door opening apparatuses”) are provided. “Door” as used herein is to be broadly defined as any tangible item that at least partially covers an opening or cavity when in a closed position, and may include, but is not limited to accordion-type doors, window shutters, room partitions, tambour doors, sliding doors, windows, or other types of items that open and close. For the embodiments, the apparatuses may include a motor such as a gearmotor and a drive wheel that may be coupled to the motor via a drive shaft. The door opening apparatuses may be adapted to operationally couple with movable door.

In various embodiments, the door opening apparatuses may be attached to the peripheral portions of doors. For these embodiments, the drive wheel may be adapted to engage a portion of a door frame. As used herein, door frame is to be broadly construed as covering any surface encompassing part or all of the door, with which the drive mechanism may engage to assist in moving the door from the open to closed position and visa versa. Examples of door frame may include, but are not limited to a doorway frame, door trim, the wall surrounding the doorway, window trim, window casings, desk surfaces, or any other components that completely or partially surrounds a door.

In some embodiments, the portion of the door frame that a drive wheel may engage may be a door rail on an accordion-type door. For these embodiments, the drive wheel may engage and roll along the external surface of the door rail when the door opening apparatus is in operation. The drive wheel may be at least partial composed of a friction promoting material such as rubber, polymer based materials or other materials that may have characteristics that allow the drive wheel to maintain good traction and or frictional engagement with a surface.

In some embodiments, the drive wheel may be coupled to the motor via a drive shaft. A bearing block may be coupled to the drive shaft, the bearing block adapted to provide inward force to the drive shaft (which is coupled to the drive wheel) urging the drive wheel towards the surface that it is in contact with assuring sufficient contact between the drive wheel and the surface. The door opening apparatus may include various other components such as DC or an AC power source, a control unit, RF receiver, and the like.

Embodiments of the present invention may be used in new door applications. Embodiments may also be particularly useful in retrofit applications, where space around the door frame is limited or access to the interior of the door frame is restricted, for example.

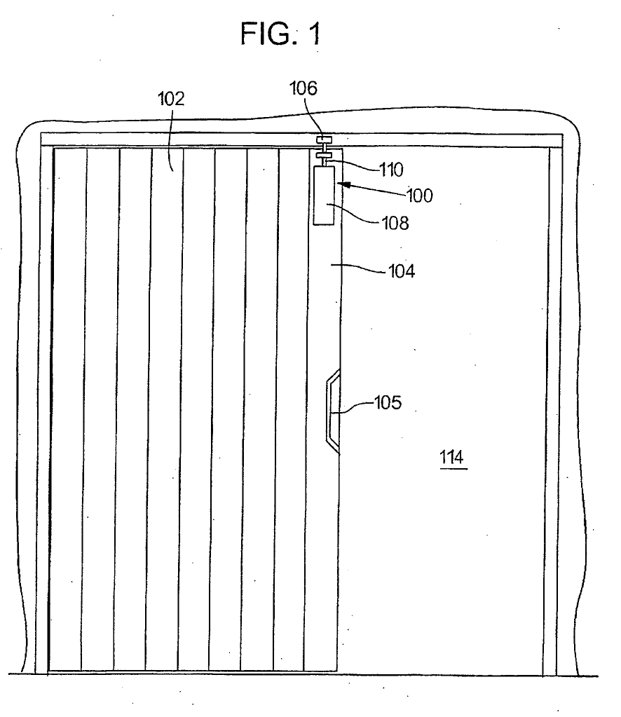

FIG. 1 depicts a door opening apparatus coupled to a door in accordance with some embodiments. Note that for purposes of this description, a door opening apparatus may open and/or close doors. For the embodiments, the door opening apparatus 100 may be coupled to the leading edge of a door 102. In particular, the door opening apparatus 100 may be coupled to the door lead rail 104, which may further include a handle 105 for manually opening and/or closing the door 102. The door opening apparatus 100 may include a drive wheel 106 coupled to a motor 108 via drive shaft 110. Although not depicted here, in some embodiments, the motor 108 and at least a portion of the drive shaft 110 may be enclosed within an enclosure or cover. In various other embodiments, the door opening apparatus 100 may further include other components that will be described in the following description.

The door 102, in this case, is an accordion-type of door that may be found, for example, in the elevators of private residences or commercial buildings. In other embodiments, however, the door opening apparatus 100 may be coupled to a variety of other types of doors, as previously discussed. In one embodiment, the door 102 may hang from a door track 112 with rollers, wheels or other mechanisms that may be operationally coupled to the top of the door lead rail 104, to facilitate opening and closing of the door. This interface allows the door 102 to be extended and/or contracted as needed. The door track 112 may be part of a door frame, such as the door trim or the wall that surrounds the doorway 114. In other embodiments, the door may be operationally disposed in a track or other guide mechanism to urge the door to open and close in a substantially consistent and uniform manner.

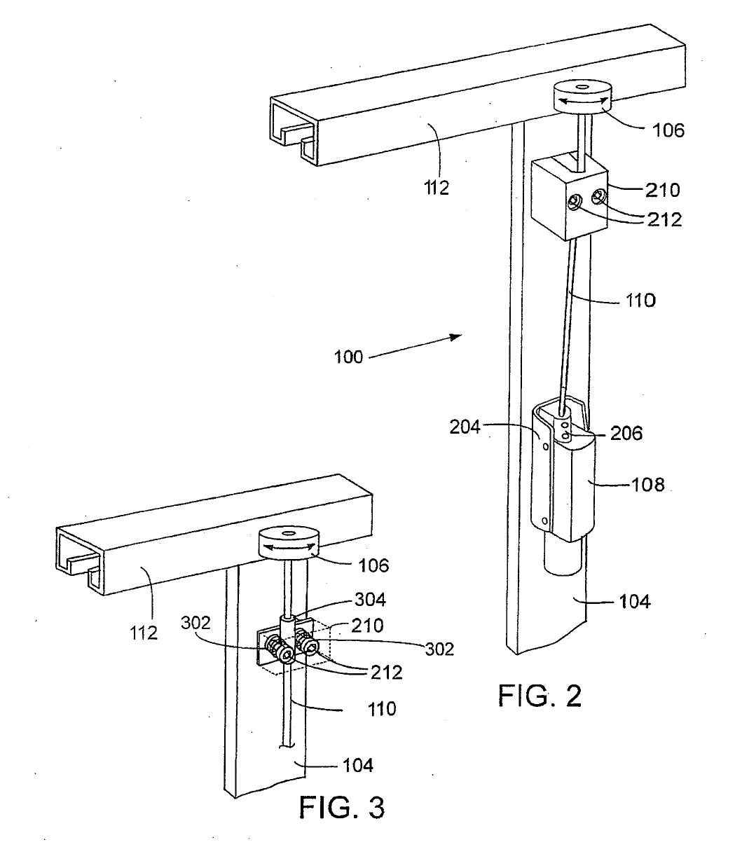

FIG. 2 is a perspective view of the door opening apparatus of FIG. 1, in accordance with some embodiments. As previously described, the door opening apparatus 100 includes a motor 108 coupled to a drive shaft 110 that is further coupled to a drive wheel 106. Door opening apparatus 100 may be coupled to the door lead rail 104 using a variety of coupling devices, such as bracket 204. Bracket 204 may be coupled to both the door lead rail 104 and the motor 108. The mounting bracket 204 may further include a coupler 206 that further couples the mounting bracket 204 to the door opening apparatus 100 by wrapping around the drive shaft 110. In various other embodiments, other types of coupling components may be employed in order to couple the door opening apparatus 100 to the door 102. For example, clamps, screws, adhesives, and the like may be used instead of or in addition to the bracket 204 to couple the door opening apparatus 100 to the door 102.

The drive wheel 106, in various embodiments, may have a circular or cylindrical shape, or may have a custom shape configured to conform to the contours of the lead rail (e.g. conical-shaped). When the door opening apparatus 100 is coupled to the door 102 (via door lead rail 104), the drive wheel 106 may be adapted to frictionally engage with the door frame, in this case, the external surface of a door track 112. In other embodiments, however, the drive wheel may be adapted to couple with other door frame components such as the wall or trim that border the doorway 114. The drive wheel 106 may be comprised of, at least externally, a friction promoting material such as rubber, vinyl, various polymers, and other elastic-type materials.

In various embodiments, the friction promoting material may have characteristics that allow the drive wheel 106 to have good traction with the external surface of the door track 112. That is, when the motor 108 is energized, the drive wheel 106 may roll or rotate along the external surface of the door track 112. By forming at least the external surface of the drive wheel 106 with an elastic material, better traction between the drive wheel 106 and the external surface of the door track 112 may be achieved. Further, by forming the drive wheel 106 with a deformable friction promoting material, irregularities such as bumps and holes that may be on the external surface of the door track 112 may be negotiated without affecting the performance.

In another embodiment of the invention, the drive wheel may be a toothed wheel such as a sprocket that may be adapted to engage with a track surface having corresponding holes in, or a chain mounted to, a rail to receive the teeth of the wheel. For such an embodiment, there may not be any need for the drive wheel to be frictionally engaged with the track surface. Instead, the traction of the wheel may depend upon the engagement of its teeth with the corresponding holes or chain slots on the track.

In various embodiments, the motor 108 may be an electric motor. For these embodiments, the electric motor may be a direct current (DC) gearmotor that may be powered by a variety of power sources. These power sources include, for example, a battery such as a 12-volt battery, an alternating current (AC) power source using, for example, an AC/DC converter and/or other power sources. In some embodiments, by controllably reversing the polarity of the motor 108, the shaft of the motor 108 (as well as the drive wheel 106) may be made to rotate either in the clockwise or counterclockwise direction as desired. As a result, the motor 108 may be used to open and/or close the door 102. In various embodiments, the shaft of the motor may have a high spin rate but with low torque. In order to slow down the rotational speed of the shaft, the motor 108 may be a gearmotor that may include gearing in order to slow the rotational speed of the shaft while increasing torque.

In some embodiments, the drive shaft 110 may be disposed through a bearing block 210, which may help assure that the drive wheel 106 maintains contact with the surface of the door track 112 for frictional engagement. In one embodiment, the bearing block 210 may include a pair of shoulder bolts 212 that are coupled to coil springs 302 (See FIG. 3) within the bearing block 210. The bearing block 210, in various embodiments, exerts an inwardly directed force on the drive shaft 110. This, in turn, results in an inward force being applied to the drive wheel 106 urging the drive wheel 106 towards the external surface of the door track 112 to facilitate operational engagement.

FIG. 3 is an exploded view of the bearing block of FIG. 2 in accordance with some embodiments. Bearing block 210 may include bolts 212, each passing through a and coil springs 302. The coil springs 302 coils around the bolts 212. The bearing block 210 may further include a sleeve bearing 304, which may partially or completely encompass the drive shaft 110. The coil springs 302 and the bolts 212, in various embodiments, act to pull or provide inward force to the drive shaft 110 towards the door lead rail 104, which may enhance frictional engagement. As a result, the drive wheel 106, which is coupled to the drive shaft 110 may be urged towards the external surface of the door track 112. The inward force generated by the coil springs 302 along with the friction promoting material that may make up the drive wheel 106 may assure that the drive wheel 106 has good traction with the external surface of the door track 112 regardless of the surface material and even when the external surface of the door track 112 has an irregular surface.

In other embodiments, the bearing block 210 may employ a different mechanism and/or components in order to provide the same inwardly directed force to the drive wheel 106. For example, in other embodiments, the bearing block 210, may include leaf springs, or other force asserting components for urging the drive shaft and drive wheel toward the surface for which the drive wheel is in frictional engagement. Additionally, the dimensions of the various components (e.g., drive wheel, drive shaft, motor, power source, and the like) of the door opening apparatus may vary depending upon several factors including, for example, the size and type of door.

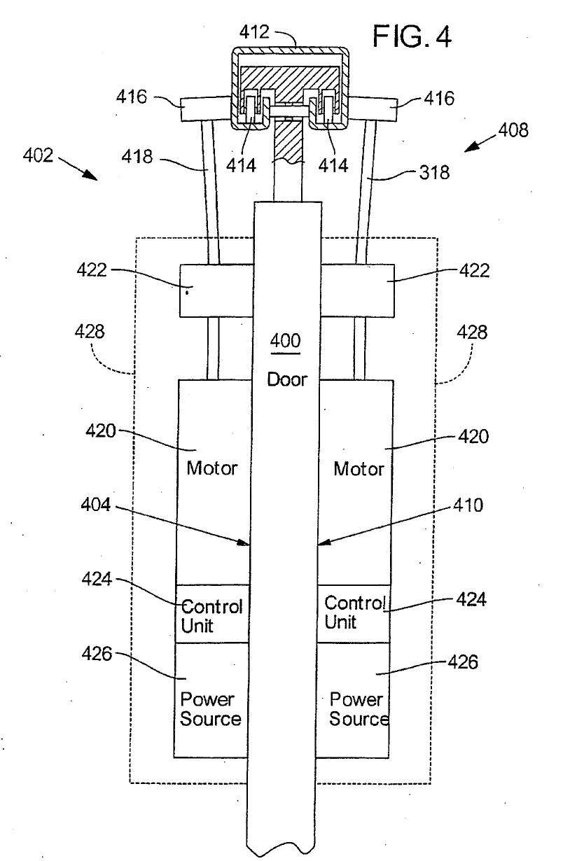

FIG. 4 depicts two door opening apparatuses disposed on opposing sides of a door in accordance with some embodiments. For the embodiments, a first door opening apparatus 402 is coupled to a first side 404 of a door 406. A second door opening apparatus 408 is coupled to a second side 410 of the door 406. The door 406 may be hung on the internal tracks of a door track 412 and may be coupled to rollers or wheels 414, which may roll along the internal tracks of the door track 412. The coupling of multiple door opening apparatuses 402 and 408 to a door 406 may be particularly advantageous when the door 406 is relatively heavy. For example, the door 406, in one embodiment, may be a heavy laterally openable door such as an airplane hanger door or industrial sliding doors.

Each of the door opening apparatuses 402 and 408 may include drive wheels 416 that are coupled to drive shafts 418. The drive shafts 418 are further coupled to motors 420. The drive shafts 418 may be further disposed within bearing blocks 422. In other embodiments, the specific structure of the door track 412 and the mechanism used for hanging and rolling the door 406 along the door track 412 may be different from the one depicted in FIG. 4.

Coupled to the motors 420 may be one or more control units 424 that are further coupled to power sources 426. In some embodiments, the motors 420 may be DC gearmotors. The control units 424 may include on/off switches as well as circuitry to control the rotational direction of the motors 420. For example, the control units 424 may have the same type of circuitry that are included in control units for garage door openers. In some embodiments, the control units 424 may include circuitry for remotely controlling the door opening apparatuses 402 and 408. For example, the control units 424 may include RF receivers for receiving control signals from a remote control device. The control units 424 may further include the type of remote control circuitry used in, for example, automatic garage door opening systems. The bearing blocks 422, the motors 420, the control units 424 and/or the power sources 426 may be housed in enclosures 428. For these embodiments, the enclosures 428 may be provided for safety reasons.

In various embodiments, the power sources 426 may be batteries such as 12-volt batteries. For these embodiments, the door opening apparatuses 402 and 408 may further include other components such as battery chargers or solar-based charging equipment. In other embodiments, however, the door opening apparatuses 402 and 408 may not include power sources 426 but instead may be powered by alternating current (AC) sources. That is, in some embodiments, the motors 420 may be connected to one or more AC/DC converters that are further coupled to an AC power supply such as an electrical outlet that may be typically found in, for example, a private residence.

The two door opening apparatuses 402 and 408, when operated together may generate greater amount of torque than when using a single door opening apparatus. Further, such a dual combination may better assure that the drive wheels 416 of each of the door opening apparatuses 402 and 408 have superior traction with the external surface of the door track 412. In addition, these multiple door opening apparatus combinations may be particularly useful when coupled to large doors, for example, the doors of an airplane hanger.

According to other embodiments, a plurality of door opening apparatuses may be disposed on a door in a different orientation than the one depicted in FIG. 4. For example, in alternative embodiments, two or more door opening apparatuses may be disposed on the same side of a door. The two or more door opening apparatuses may or may not be located adjacent to each other on the same side of the door. For these embodiments, one or more of the door opening apparatuses may be located at the bottom of the door lead rail instead of at the top of the door lead rail as depicted in FIG. 4. As can be seen, many other variations of coupling one or more door opening apparatuses to a door are possible.

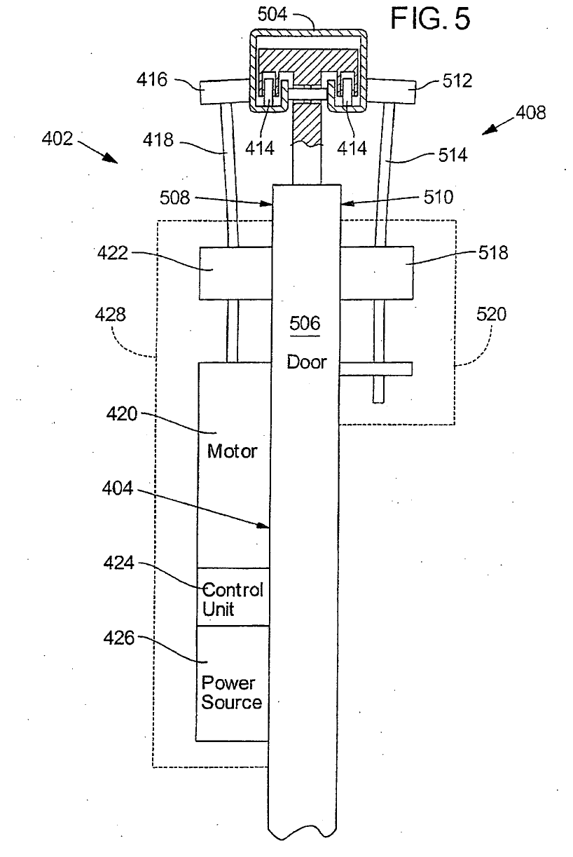

FIG. 5 depicts a door opening apparatus and an idler wheel component disposed on opposite sides of a door in accordance with some embodiments. An idler wheel component 502 may assure that the drive wheel 416 of the opposing door opening apparatus 402 maintains good contact with the external surface of the door track 504. In various embodiments, the door 506 may hang and roll along the internal tracks of the door track 504. The door 506 has a door opening apparatus 402 on a first side 508 while an idler wheel component 502 is disposed on the second side 510 opposite the first side 508. The door opening apparatus 402 may include a drive wheel 416, a drive shaft 418, a bearing block 422, a motor 420, a control unit 424 and a power source 426. The bearing block 422, the motor 420, the control unit 424 and/or the power source 426 may be housed in an enclosure. 428.

In various embodiments, the idler wheel component 502 may include an idler wheel 512, an idler shaft 514 coupled to the idler wheel 512, and a support 516 that holds in place the idler shaft 514. The idler shaft 514 may further be disposed through a bearing block 518. For safety considerations, the bearing block 518 and/or support 516 may be housed in an enclosure 520. The bearing block 518 may be similar to the bearing block of FIG. 3 and may assure that there is inward force (e.g., towards the door 506) on the idler wheel 512. In various embodiments, the idler wheel component 502 may assure that the drive wheel 416 of the door opening apparatus 402 maintains good contact with the external surface of the door track 504. As with the door opening apparatus 402, the idler wheel component 502 may be attached to the door lead rail of the door 506.

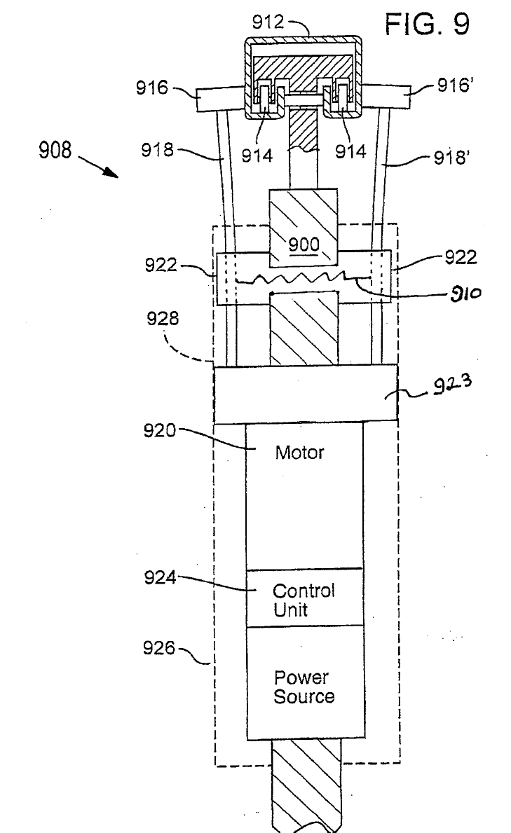

FIG. 9 illustrates an enlarged cross sectional view of a door opening apparatus 908 in accordance with an embodiment of the present invention. A single motor 920 may be at least partially disposed within the door rail 930 of door 900. In one embodiment, the door 900 may be configured to be operably coupled to door track 912 and may be coupled to rollers or wheels 914, which may movably engage door track 912. In other embodiments, the specific structure of the door track 912 and the mechanism used for hanging and rolling the door 900 along the door track 912 may be different from the one depicted in FIG. 9.

Motor 920 may be adapted to directly drive a first and a second shaft 918 and 918′, which in turn may be coupled to drive wheels 916 and 916′. The drive shafts 918 and 918′ may be further disposed within a bearing block 922. In one embodiment, bearing block may include a tension spring 910 coupling shafts 918 and 918′ together, such that both are urged inward to help cause frictional engagement of the drive wheels 916 and 916′ with door track 912. In one embodiment, motor 920 may be coupled to shafts 918 and 918′ through a gearing mechanism 923. Gearing mechanism 923 may be adapted to translate the rotation of the motor drive shaft to each of the shafts 918 and 918′ such that they cooperatively rotate to assist in opening and closing the door 900.

Coupled to the motor 920 may be one or more control units 924 that may be further coupled to power sources 926. In some embodiments, the motor 920 may be DC gearmotors. The control units 924 may include on/off switches as well as circuitry to control the rotational direction of the motor 920. For example, the control unit 924 may have the same type of circuitry that are included in control units for garage door openers. In some embodiments, the control units 924 may include circuitry for remotely controlling the door opening apparatuses 908. For example, the control unit 924 may include RF receivers for receiving control signals from a remote control device. The bearing block 922, the motor 920, the control unit 924 and/or the power source 926 may be housed in enclosures 928.

Configurations in accordance with embodiments similar to FIG. 9, may allow for a lower profile door opening apparatus, while allowing for the added torque of two or more drive wheels in an opposing relationship. Such configurations may also allow for use of a larger motor, again with out unduly protruding from one side of a door or another.

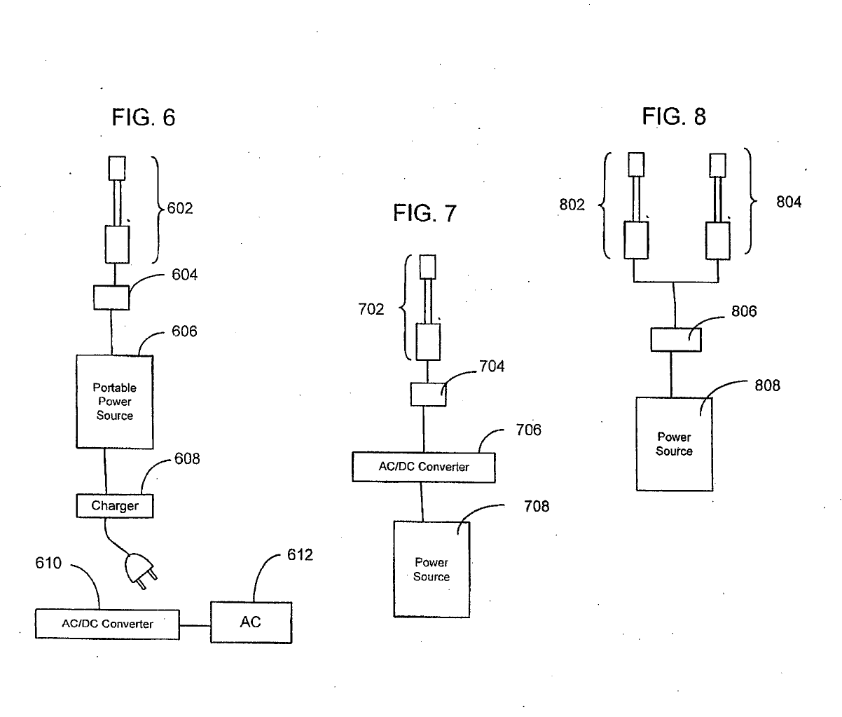

FIGS. 6 to 8 are block diagrams that depicts various schemes for powering and/or controlling the door opening apparatuses described above in accordance with various embodiments. In particular, FIG. 6 depicts a door opening apparatus 602 coupled to a control unit 604 in accordance with some embodiments. For these embodiments, the control unit 604 may be coupled to a portable power source 606. The portable power source 606 may further be coupled to a charger 608. In various embodiments, the portable power source 606, as previously described, may be a battery such as a 12-volt battery. The charger 608 may be used to charge the portable power source 606 by connecting the charger 608 to an AC/DC converter (adapter) 610 that may be coupled to an AC power source 612. The AC power source 612, in some instances, may be the power outlet of a, for example, private residence or business. Thus, when the door opening apparatus 602 is in use, the portable power source 606 may be periodically recharged by “plugging” the charger 608 to the AC/DC converter 610.

Although FIG. 6 shows the charger 608 as being coupled to a plug via a chord, in other embodiments, the charger 608 may be directly coupled to a plug or an electrical contact that is located, for example, at the lead rail of the door. For these embodiments, the plug or electrical contact of the door opening apparatus may be electrically coupled to a socket or electrical contact of a power source whenever, for example, the door is closed. That is, the corresponding socket or electrical contact of the power source may be strategically located along the door frame so that the plug or electrical contact of the door opening apparatus will mate with the socket or electrical contact of the power source whenever the door is closed. This may eliminate the need to, for example, “plug” the plug of the door opening apparatus into a power socket whenever recharging of the portable power source 606 is required. Instead, the portable power source 606 may be automatically recharged by keeping the door closed.

FIG. 7 depicts a door opening apparatus that receives power from an AC power source in accordance with some embodiments. For the embodiments, the door opening apparatus 702 is coupled to a control unit 704, which in turn is coupled to an AC/DC converter 706. The AC/DC converter 706 may be coupled to an AC source 708 such as the power outlet of a private residence or business. If the AC/DC converter 706 along with the door opening apparatus 702 is located on a door then the connection between the AC/DC converter 706 and the power source 708 may be a long extension having sufficient length to maintain connection with the AC/DC power source (e.g., electrical outlet) regardless of whether the door is in the open or close position.

FIG. 8 depicts a pair of door opening apparatuses that may be operated together in order to open and/or close a door in accordance with some embodiments. For the embodiments, the pair of door opening apparatuses 802 and 804 may be coupled to a control unit 806, which in turn may be coupled to a common power source 808. By coupling the two door opening apparatuses 802 and 804, the two door opening apparatuses 802 and 804 may be operated in a synchronous manner.

The control unit 806 may contain circuitry that controls the power being directed to the two door opening apparatuses 802 and 804. For these embodiments, the power source 808 may be either a DC power source such as a battery or an AC power source. In the case where the power source is an AC power source, the power source 808 may further include an AC/DC converter.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the embodiments of the present invention. Therefore, it is manifestly intended that this invention be limited only by the claims.

1. A door opening apparatus, comprising:
a motor, the motor adapted to couple with a door; and
a drive wheel operationally coupled to the motor, the drive wheel having a contact surface adapted to engage a portion of a door frame.

2. The apparatus of claim 1, wherein the apparatus further comprises a coupling component to couple the apparatus to the door.

3. The apparatus of claim 2, wherein the coupling component is a mounting bracket.

4. The apparatus of claim 1, wherein the motor is a gearmotor.

5. The apparatus of claim 1, wherein the motor is a direct current (DC) motor.

6. The apparatus of claim 1, wherein the drive wheel is coupled to the motor via a drive shaft.

7. The apparatus of claim 6, further comprising a bearing block coupled to the drive shaft, the bearing block adapted to provide a force sufficient to urge the drive wheel towards the door frame assuring contact between the drive wheel and the door frame.

8. The apparatus of claim 7, wherein the bearing block comprises one or more springs to generate the force.

9. The apparatus of claim 7, wherein the bearing block is adapted to couple with the door.

10. The apparatus of claim 1, wherein the contact surface of the drive wheel includes a friction promoting material adapted to enhance traction of the wheel with the door frame.

11. The apparatus of claim 1, wherein the apparatus coupled to a power source.

12. The apparatus of claim 11, wherein the power source is a battery.

13. The apparatus of claim 11, wherein the apparatus is coupled to a control unit adapted to control the direction that the motor turns the drive wheel.

14. The apparatus of claim 13, wherein the control unit includes a radio frequency (RF) receiver to receive control signals.

15. The apparatus of claim 1, further comprising a second drive wheel operationally coupled to an opposite side of the door and adapted to operationally engage the door frame.

16. The apparatus of claim 15, wherein the motor is operationally coupled to the second drive wheel.

17. An apparatus, comprising:
a door adapted to open an close, the door comprising a first side and an opposite second side;
a first motor coupled to the door; and
a first drive wheel operationally coupled to the motor, the first drive wheel adapted to engage a portion of a door frame.

18. The apparatus of claim 17, wherein the first motor is adapted to couple with a laterally opening door.

19. The apparatus of claim 18, wherein the door is one selected from the group consisting of an accordion door, a window shutter, a room partition, sliding door, garage door, and a hanger door.

20. The apparatus of claim 17, wherein the door includes a lead rail and the first motor is coupled to the door lead rail.

21. The apparatus of claim 20, wherein the first motor is disposed at least partially in the lead rail.

22. The apparatus of claim 21, further comprising a second drive wheel adapted to operationally engage a second portion of the door frame and further operationally coupled to the first motor.

23. The apparatus of claim 17, further comprising:
a second motor coupled to the second side of the door; and
a second drive wheel operationally coupled to the second motor, the second drive wheel adapted to engage a portion of a door frame.

24. The apparatus of claim 17, further comprising an idler wheel component, the idler wheel component coupled to the second side of the door.

25. The apparatus of claim 24, wherein the idler wheel component comprises an idler wheel coupled to an idler shaft, the idler shaft coupled to a bearing block, the bearing block adapted to provide a force adapted to urge the idler shaft towards the door.

26. The apparatus of claim 24, wherein the door comprises a door lead rail having a first and second side, the first motor and drive wheel disposed on the first side and the idler wheel component disposed on the second side.

27. The apparatus of claim 16, wherein the first wheel and second wheel are disposed on opposite sides of the door frame, and a biasing member is adapted to urge the first and second wheels against the door frame with approximately the same force.

28. The apparatus of claim 27, wherein the first and second drive wheel each have an axis of rotation which are off set from each other with respect to the door frame, and wherein the biasing member is a set screw adapted controllably apply the force to the first and second drive wheels in a torsional manner.

29. The apparatus of claim 11, wherein a converter supplies the power to the apparatus in the form of a 12 volt power source.

30. The apparatus of claim 13, wherein the control unit is adapted to receive and send signals in the form of a voltage that is less than 43 volts.
